(19) United States
(12) Patent Application Publication
(10) Pub. No.: US 2023/0244986 A1
(43) Pub. Date: Aug. 3, 2023

(54) ARTIFICIAL INTELLIGENCE SYSTEM FOR EVENT VALUATION DATA FORECASTING

(71) Applicant: Optum Services (Ireland) Limited, Dublin (IE)

(72) Inventors: Cian G. Clifford, Dublin (IE); Giannis Morfis, Dublin (IE); David T. Cleere, Dublin (IE)

(21) Appl. No.: 17/592,156

(22) Filed: Feb. 3, 2022

(51) Int. Cl. G06N 20/00

(52) U.S. Cl. CPC G06N 20/00

(57) ABSTRACT

Various embodiments of the present disclosure provide event valuation forecasting using machine learning. In one example, an embodiment provides for determining one or more utilization forecast features for a classification identifier based at least in part on a first regression machine learning model and using utilization data associated with the classification identifier, determining one or more updated utilization forecast features for the classification identifier based at least in part on a second regression machine learning model and using the one or more utilization forecast features and one or more event features for one or more events associated with the classification identifier, combining the one or more updated utilization forecast features with one or more valuation features for the classification identifier to determine an event valuation forecast for the classification identifier, and performing one or more actions based at least in part on the event valuation forecast for the classification identifier.

### BACKGROUND

The present disclosure addresses technical challenges related to analysis of digital data in an accurate, computationally efficient and predictively reliable manner. Existing systems are generally ill-suited to accurately, efficiently and reliably analyze and/or generate data in various storage systems, such as storage systems that are associated with high-dimensional feature spaces with a high degree of size, diversity and/or cardinality.

### BRIEF SUMMARY

In general, embodiments of the present disclosure provide methods, apparatus, systems, computing devices, computing entities, and/or the like for analysis of digital data using artificial intelligence. Certain embodiments utilize methods, apparatus, systems, computing devices, computing entities, and/or the like for additionally performing actions based at least in part on the analysis of the digital data. Additionally, in certain embodiments, methods, apparatus, systems, computing devices, computing entities, and/or the like provide for a computer-based solution and/or a machine learning solution that provides for event valuation data forecasting.

In accordance with one embodiment, a computer-implemented method for event valuation forecasting is provided. The computer-implemented method provides for determining one or more utilization forecast features for a classification identifier based at least in part on a first regression machine learning model and using utilization data associated with the classification identifier. The computer-implemented method also provides for determining one or more updated utilization forecast features for the classification identifier based at least in part on a second regression machine learning model and using the one or more utilization forecast features and one or more event features for one or more events associated with the classification identifier. The computer-implemented method also provides for combining the one or more updated utilization forecast features with one or more valuation features for the classification identifier to determine an event valuation forecast for the classification identifier. Furthermore, the computer-implemented method provides for performing one or more actions based at least in part on the event valuation forecast for the classification identifier.

In accordance with another embodiment, an apparatus comprising at least one processor and at least one memory including computer program code is provided. The at least one memory and the computer program code can be configured to, with the processor, cause the apparatus to determine one or more utilization forecast features for a classification identifier based at least in part on a first regression machine learning model and using utilization data associated with the classification identifier. The at least one memory and the computer program code can also be configured to, with the processor, cause the apparatus to determine one or more updated utilization forecast features for the classification identifier based at least in part on a second regression machine learning model and using the one or more utilization forecast features and one or more event features for one or more events associated with the classification identifier. The at least one memory and the computer program code can also be configured to, with the processor, cause the apparatus to combine the one or more updated utilization forecast features with one or more valuation features for the classification identifier to determine an event valuation forecast for the classification identifier. The at least one memory and the computer program code can also be configured to, with the processor, cause the apparatus to perform one or more actions based at least in part on the event valuation forecast for the classification identifier.

In accordance with yet another embodiment, a computer program product is provided. The computer program product can comprise at least one non-transitory computer-readable storage medium comprising instructions, the instructions being configured to cause one or more processors to at least perform operations configured to determine one or more utilization forecast features for a classification identifier based at least in part on a first regression machine learning model and using utilization data associated with the classification identifier. The instructions can also be configured to cause the one or more processors to at least perform operations configured to determine one or more updated utilization forecast features for the classification identifier based at least in part on a second regression machine learning model and using the one or more utilization forecast features and one or more event features for one or more events associated with the classification identifier. The instructions can also be configured to cause the one or more processors to at least perform operations configured to combine the one or more updated utilization forecast features with one or more valuation features for the classification identifier to determine an event valuation forecast for the classification identifier. The instructions can also be configured to cause the one or more processors to at least perform operations configured to perform one or more actions based at least in part on the event valuation forecast for the classification identifier.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of an architecture that can be used to practice one or more embodiments of the present disclosure.

FIG. 2 provides an example artificial intelligence computing entity in accordance with one or more embodiments discussed herein.

FIG. 3 provides an example external computing entity in accordance with one or more embodiments discussed herein.

FIG. 4 provides an example system that provides for utilization modeling using machine learning in accordance with one or more embodiments discussed herein.

FIG. 5 provides an example system that provides for event valuation modeling using machine learning in accordance with one or more embodiments discussed herein.

FIG. 6 provides an example system that provides for event valuation forecast actions and/or visualizations in accordance with one or more embodiments discussed herein.

FIG. 7 provides an example system that provides for regression machine learning model generation in accordance with one or more embodiments discussed herein.

FIG. 8 is a flowchart diagram of an example process for providing event valuation forecasting using machine learning in accordance with one or more embodiments discussed herein.

### DETAILED DESCRIPTION

Various embodiments of the present disclosure now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present disclosure are described with reference to predictive data analysis, one of ordinary skill in the art will recognize that the disclosed concepts can be used to perform other types of data analysis.

### I. Overview and Technical Improvements

Discussed herein are methods, apparatus, systems, computing devices, computing entities, and/or the like to facilitate event valuation forecasting using artificial intelligence. As will be recognized, the disclosed concepts can be used to perform any type of artificial intelligence for event valuation forecasting. Examples of artificial intelligence include, but are not limited to, machine learning, linear regression modeling, supervised machine learning, unsupervised machine learning, deep learning, neural network architectures, and/or the like.

Healthcare organizations often employ information from disparate database systems to facilitate providing one or more products and/or one or more services. However, it is generally difficult to accurately, efficiently and/or reliably provide forecasts related to data from disparate database systems. For example, to forecast valuations related to medications such as, for example, wholesale acquisition cost (WAC) of medications, there are currently no products or technological solutions that include an adequate number and/or beneficial types of factors to accurately forecast total WAC of medications. Furthermore, existing technological solutions generally involve manual techniques to provide forecasts related to data from disparate database systems. These manual techniques generally involve numerous resource-hours to build, are slow to replicate, and/or are prone to human-error. As such, existing technological solutions for providing forecasts related to data from disparate database systems remains a challenge.

Various embodiments of the present disclosure address technical challenges related to accurately, efficiently and/or reliably providing forecasts related to data from disparate database systems. In various embodiments, a machine learning solution associated with forecasting statistical models and/or rules-based techniques is employed to provide forecasts related to data from disparate database systems. In one or more embodiments, a machine learning solution is employed to provide improved forecasting of a medication valuation (e.g., improved WAC forecasting) by utilizing forecasting statistical models and/or rules-based techniques to forecast valuation of a medication using certain medication factors (e.g., medication utilization and/or medication price). Furthermore, a forecasted medication valuation can also be adjusted based on future events related to a medication (e.g., a formulary change or a generic launch of a medication). Optimized medication valuation forecasting can therefore be provided. In one or more embodiments, the improved medication valuation forecasting can be employed as an insight to assist with one or more healthcare decision-making processes such as, for example, rebate optimization for a medication. In an example, rebates invoiced and/or collected from merchants (e.g., pharmacies) are generally calculated as a percentage of total WAC (e.g., drug spend).

In various embodiments, to facilitate the improved forecasting of medication valuations, a medication utilization model can be employed in combination with a future event model (e.g., a generic launch & formulary model) and/or a medication valuation forecasting model to provide improved medication valuation forecasts. Output of one model can be provided as input for a next model. Furthermore, respective models can capture respective influencing factors as input features for prediction. In one or more embodiments, a modeling sequence to facilitate forecasting of medication valuations can employ a combination of time series models, event-based models, and/or interest growth rate models. For example, the modeling sequence can include a linear regression model to predict future baseline medication utilization, a Least Absolute Shrinkage and Selection Operator (F) regression model to update the medication utilization forecast due to formulary changes and/or generic launches associated with the medication, and/or a weighted Compound Annual Growth Rate (CAGR) model to predict future medication valuations. In one or more embodiments, medication utilization output from the linear regression model and/or the LASSO regression model is combined with the medication valuation output from the weighted CAGR model as a predicted medication unit valuation combined with a forecasted medication utilization to provide a forecasted output (e.g., a forecasted total WAC). The forecasted output is stored, for example, in a database for reporting and/or decision-making purposes. In certain embodiments, a front-end visualization can also be provided for end-users to engage with the forecasted output. The modeling sequence provides significant advantages over existing technological solutions such as, for example, improved integrability, reduced complexity, improved accuracy, and/or improved speed as compared to existing technological solutions.

Accordingly, by employing various techniques for providing event valuation forecasting using machine learning, various embodiments of the present disclosure enable utilizing efficient and reliable machine learning solutions to process high-dimensional feature spaces with a high degree of size, diversity and/or cardinality. In doing so, various embodiments of the present disclosure address shortcomings of existing system solutions and enable solutions that are capable of accurately, efficiently and/or reliably providing event valuation forecasts to facilitate optimal decisions and/or actions related to the health information. Moreover, by employing various techniques for providing event valuation forecasting using machine learning, one or more other technical benefits can be provided, including improved interoperability, improved reasoning, reduced errors, improved information/data mining, improved analytics, and/or the like related to machine learning.

### II. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations. Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### III. Exemplary System Architecture

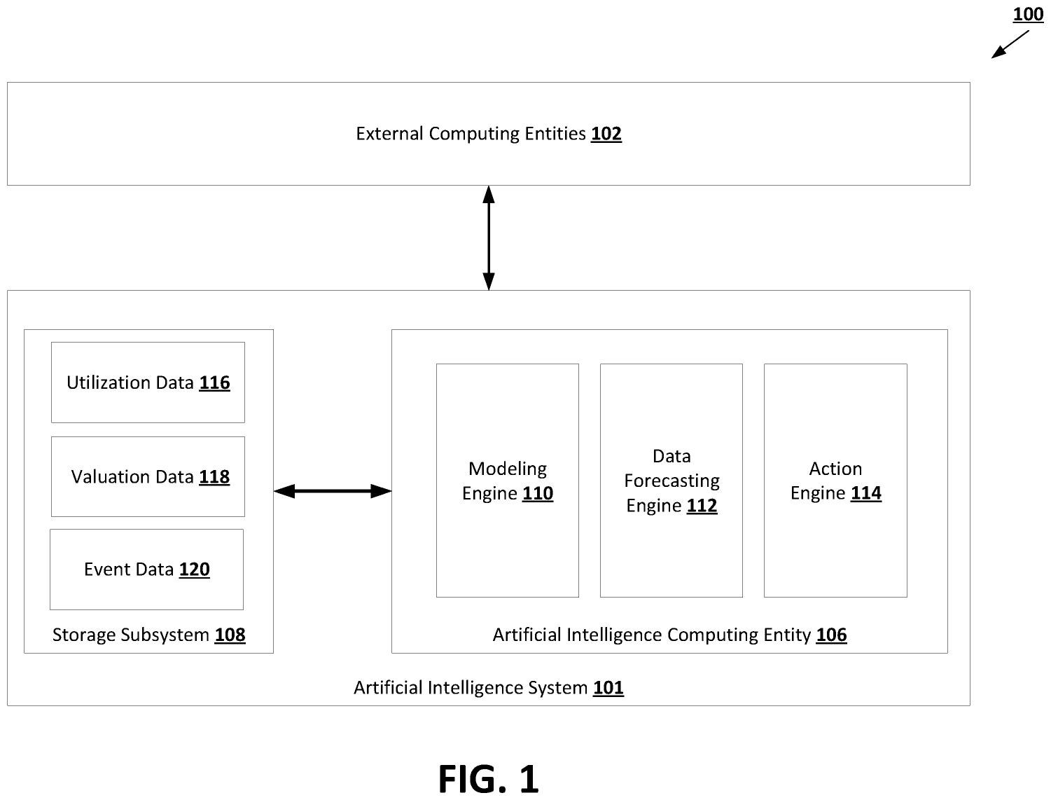

FIG. 1 provides an exemplary overview of an architecture 100 that can be used to practice embodiments of the present disclosure. The architecture 100 includes an artificial intelligence system 101 and one or more external computing entities 102. For example, at least some of the one or more external computing entities 102 can provide inputs to the artificial intelligence system 101. Additionally or alternatively, at least some of the one or more external computing entities 102 can receive decision outputs, task outputs and/or action outputs from the artificial intelligence system 101 in response to providing the inputs. As another example, at least some of the external computing entities 102 can provide one or more data streams and/or one or more batch loads to the artificial intelligence system 101 and request performance of particular prediction-based actions in accordance with the provided one or more data streams and/or one or more batch loads. As a further example, at least some of the external computing entities 102 can provide training data to the artificial intelligence system 101 and request training of one or more machine learning models in accordance with the provided training data. In some of the noted embodiments, the artificial intelligence system 101 can be configured to transmit parameters, hyper-parameters, and/or weights of a trained machine learning model to the external computing entities 102.

In some embodiments, the artificial intelligence system 101 can include an artificial intelligence computing entity 106. The artificial intelligence computing entity 106 and the external computing entities 102 can be configured to communicate over a communication network (not shown). The communication network can include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

Additionally, in some embodiments, the artificial intelligence system 101 can include a storage subsystem 108. The artificial intelligence computing entity 106 can be configured to provide one or more predictions using one or more artificial intelligence techniques. For instance, the artificial intelligence computing entity 106 can be configured to determine forecasts related to data from disparate database systems, forecast event valuations related to medications, compute optimal decisions, display optimal data for a dashboard (e.g., a graphical user interface), generate optimal data for reports, optimize actions, and/or optimize configurations associated with a decision management system and/or a workflow management system. The artificial intelligence computing entity 106 includes a modeling engine 110, a data forecasting engine 112, and/or an action engine 114. In some embodiments, the modeling engine 110 can determine one or more features associated with utilization data 116, valuation data 118, and/or event data 120. In one or more embodiments, the utilization data 116, the valuation data 118, and/or the event data 120 can be stored in the storage subsystem 108. The storage subsystem 108 can include one or more storage units, such as multiple distributed storage units that are connected through a computer network. In certain embodiments, the utilization data 116, the valuation data 118, and/or the event data 120 can be stored in disparate storage units (e.g., disparate databases) of the storage subsystem 108. Each storage unit in the storage subsystem 108 can store at least one of one or more data assets and/or one or more data about the computed properties of one or more data assets. Moreover, each storage unit in the storage subsystem 108 can include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

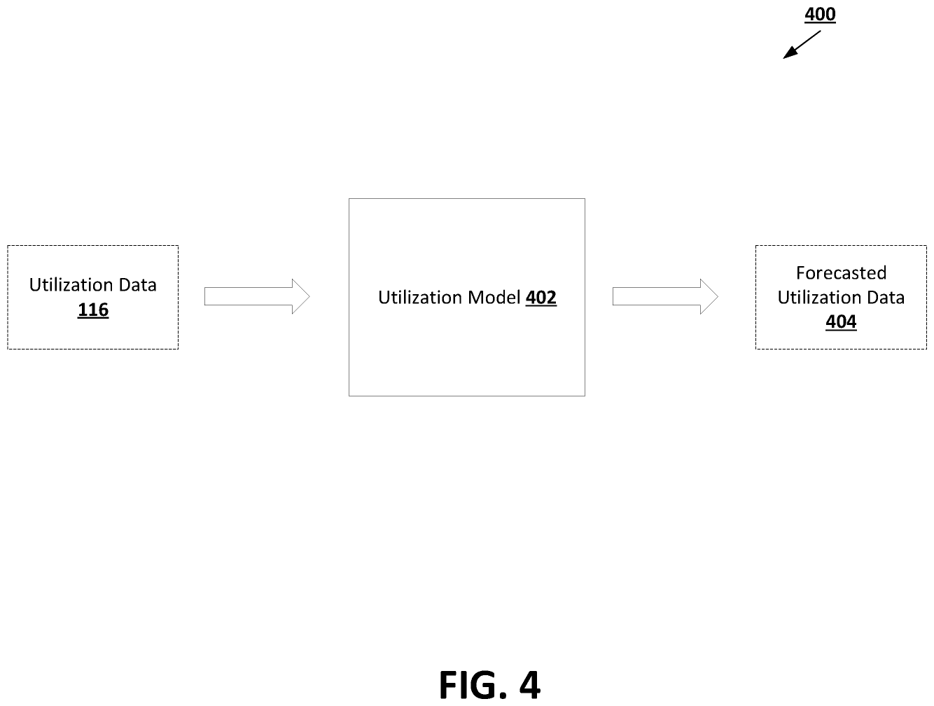

The data forecasting engine 112 can employ features associated with the utilization data 116, the valuation data 118, and/or the event data 120 to provide forecasts related to the utilization data 116, the valuation data 118, and/or the event data 120. In one or more embodiments, the data forecasting engine 112 can employ features associated with the utilization data 116, the valuation data 118, and/or the event data 120 to provide forecasts related to event valuations for medications. The action engine 114 can employ the forecasts associated with the data forecasting engine 112 to perform one or more actions. In certain embodiments, the action engine 114 can employ the forecasts associated with the data forecasting engine 112 to provide one or more visualizations via user interface of a display (e.g., display 316). In certain embodiments, the action engine 114 can employ the forecasts associated with the data forecasting engine 112 to optimize one or more machine learning models employed by the modeling engine 110. As such, the artificial intelligence computing entity 106 can provide accurate, efficient and/or reliable predictive data analysis for providing event valuation forecasting using machine learning. Further example operations of the modeling engine 110, the data forecasting engine 112 and/or the action engine 114 are described with reference to FIGS. 4-8.

Various embodiments provide technical solutions to technical problems corresponding to data processing. In particular, data processing techniques related to data stored in disparate data sources tends to be resource intensive and time intensive. For example, continually querying a data structure would significantly slow down a data ingestion processes and/or would require significantly more computational resources. However, with the architecture 100 and one or more other embodiments disclosed herein, one or more technical improvements can be provided such as a reduction in computationally intensiveness and time intensiveness needed for automated managing, ingesting, monitoring, updating, and/or extracting/retrieving of data for providing event valuation forecasting using machine learning. With the architecture 100 and one or more other embodiments disclosed herein, reduction in computational resources required for automated managing, ingesting, monitoring, updating, and/or extracting/retrieving of data for providing event valuation forecasting using machine learning can also be provided. The architecture 100 can also allocate processing resources, memory resources, and/or other computational resources to other tasks while executing one or more processes related to providing event valuation forecasting using machine learning in parallel. As such, various embodiments of the present disclosure therefore provide improvements to the technical field of processing and/or analyzing data from disparate network systems. In certain embodiments, a graphical user interface of a computing device that renders at least a portion of event valuation forecasting data can also be improved.
A. Exemplary Artificial Intelligence Computing Entity

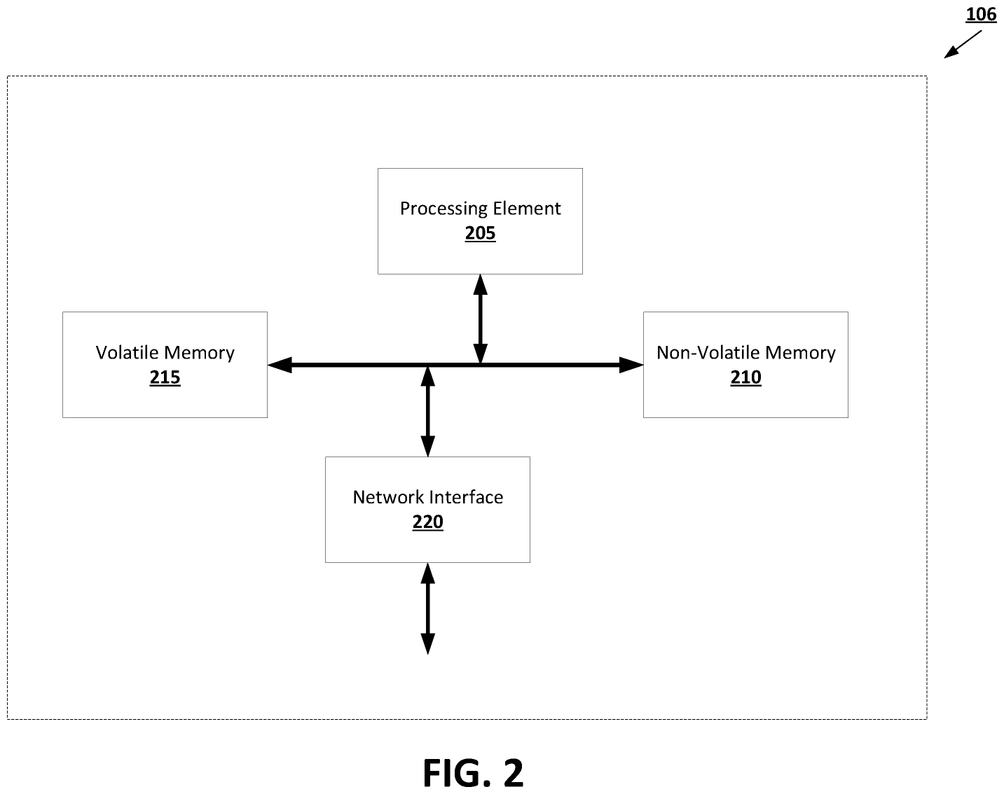

FIG. 2 provides a schematic of the artificial intelligence computing entity 106 according to one embodiment of the present disclosure. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes can include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the artificial intelligence computing entity 106 can also include a network interface 220 for communicating with various computing entities, such as by communicating data, content, information, and/or similar terms used herein interchangeably that can be transmitted, received, operated on, processed, displayed, stored, and/or the like. Furthermore, it is to be appreciated that the network interface 220 can include one or more network interfaces.

As shown in FIG. 2, in one embodiment, the artificial intelligence computing entity 106 can include or be in communication with processing element 205 (also referred to as processors, processing circuitry, and/or similar terms used herein interchangeably) that communicate with other elements within the artificial intelligence computing entity 106 via a bus, for example. It is to be appreciated that the processing element 205 can include one or more processing elements. As will be understood, the processing element 205 can be embodied in a number of different ways. For example, the processing element 205 can be embodied as one or more complex programmable logic devices (CPLDs), microprocessors, multi-core processors, coprocessing entities, application-specific instruction-set processors (ASIPs), microcontrollers, and/or controllers. Further, the processing element 205 can be embodied as one or more other processing devices or circuitry. The term circuitry can refer to an entirely hardware embodiment or a combination of hardware and computer program products. Thus, the processing element 205 can be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 can be configured for a particular use or configured to execute instructions stored in volatile or non-volatile media or otherwise accessible to the processing element 205. As such, whether configured by hardware or computer program products, or by a combination thereof, the processing element 205 can be capable of performing steps or operations according to embodiments of the present disclosure when configured accordingly.

In one embodiment, the artificial intelligence computing entity 106 can further include or be in communication with non-volatile memory 210. The non-volatile memory 210 can be non-volatile media (also referred to as non-volatile storage, memory, memory storage, memory circuitry and/or similar terms used herein interchangeably). Furthermore, in an embodiment, non-volatile memory 210 can include one or more non-volatile storage or memory media, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media can store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably can refer to a collection of records or data that is stored in a computer-readable storage medium using one or more database models, such as a hierarchical database model, network model, relational model, entity—relationship model, object model, document model, semantic model, graph model, and/or the like.

In one embodiment, the artificial intelligence computing entity 106 can further include or be in communication with volatile memory 215. The volatile memory 215 can be volatile media (also referred to as volatile storage, memory, memory storage, memory circuitry and/or similar terms used herein interchangeably). Furthermore, in an embodiment, the volatile memory 215 can include one or more volatile storage or memory media, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media can be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like can be used to control certain aspects of the operation of the artificial intelligence computing entity 106 with the assistance of the processing element 205 and operating system.

As indicated, in one embodiment, the artificial intelligence computing entity 106 can also include the network interface 220. In an embodiment, the network interface 220 can be one or more communications interfaces for communicating with various computing entities, such as by communicating data, content, information, and/or similar terms used herein interchangeably that can be transmitted, received, operated on, processed, displayed, stored, and/or the like. Such communication can be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the artificial intelligence computing entity 106 can be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the artificial intelligence computing entity 106 can include or be in communication with one or more input elements, such as a keyboard input, a mouse input, a touch screen/display input, motion input, movement input, audio input, pointing device input, joystick input, keypad input, and/or the like. The artificial intelligence computing entity 106 can also include or be in communication with one or more output elements (not shown), such as audio output, video output, screen/display output, motion output, movement output, and/or the like.
B. Exemplary External Computing Entity

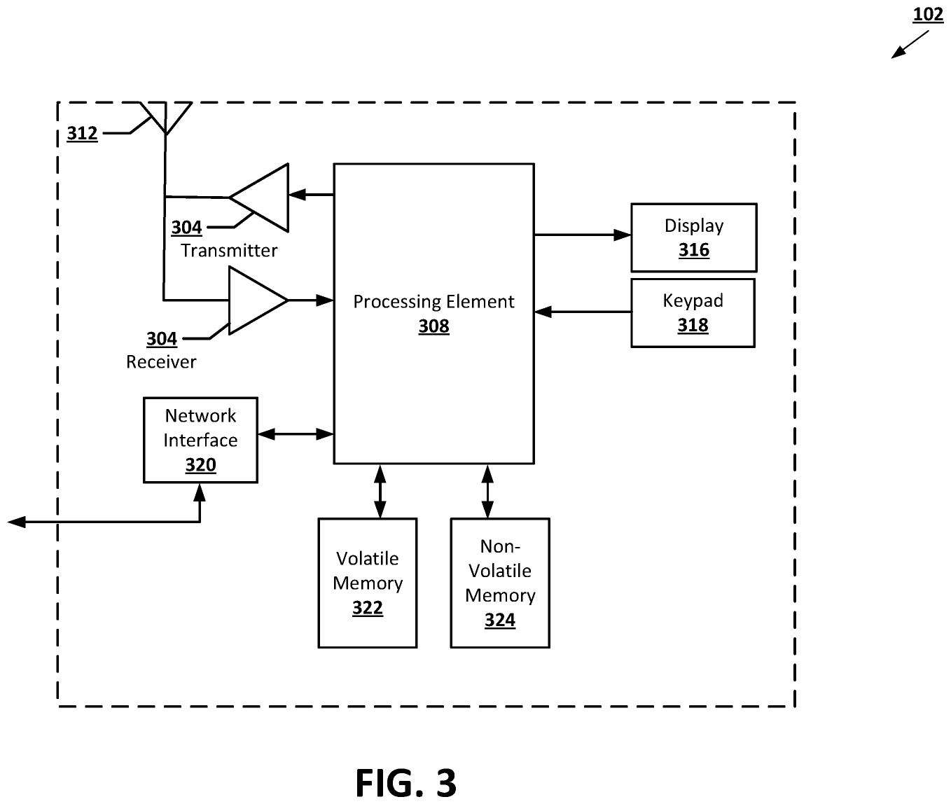

FIG. 3 provides an illustrative schematic representative of an external computing entity 102 that can be used in conjunction with embodiments of the present disclosure. In general, the terms device, system, computing entity, entity, and/or similar words used herein interchangeably can refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. The external computing entity 102 can be operated by various parties. As shown in FIG. 3, the external computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, can include signaling information/data in accordance with air interface standards of applicable wireless systems. In this regard, the external computing entity 102 can be capable of operating with one or more air interface standards, communication protocols, modulation types, and access types. More particularly, the external computing entity 102 can operate in accordance with any of a number of wireless communication standards and protocols, such as those described above with regard to the artificial intelligence computing entity 106. In a particular embodiment, the external computing entity 102 can operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 102 can operate in accordance with multiple wired communication standards and protocols, such as those described above with regard to the artificial intelligence computing entity 106 via a network interface 320.

Via these communication standards and protocols, the external computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 102 can also download changes, add-ons, and updates, for instance, to its firmware, software (e.g., including executable instructions, applications, program modules), and operating system.

According to one embodiment, the external computing entity 102 can include location determining aspects, devices, modules, functionalities, and/or similar words used herein interchangeably. For example, the external computing entity 102 can include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites can be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the external computing entity's 102 position in connection with a variety of other systems, including cellular towers, Wi-Fi access points, and/or the like. Similarly, the external computing entity 102 can include indoor positioning aspects, such as a location module adapted to acquire, for example, latitude, longitude, altitude, geocode, course, direction, heading, speed, time, date, and/or various other information/data. Some of the indoor systems can use various position or location technologies including RFID tags, indoor beacons or transmitters, Wi-Fi access points, cellular towers, nearby computing devices (e.g., smartphones, laptops) and/or the like. For instance, such technologies can include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The external computing entity 102 can also comprise a user interface (that can include a display 316 coupled to the processing element 308) and/or a user input interface (coupled to the processing element 308). For example, the user interface can be a user application, browser, user interface, graphical user interface, dashboard, and/or similar words used herein interchangeably executing on and/or accessible via the external computing entity 102 to interact with and/or cause display of information/data from the artificial intelligence computing entity 106, as described herein. The user input interface can comprise any of a number of devices or interfaces allowing the external computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the external computing entity 102 and can include a full set of alphabetic keys or set of keys that can be activated to provide a full set of alphanumeric keys. In addition to providing input, the user input interface can be used, for example, to activate or deactivate certain functions, such as screen savers and/or sleep modes.

The external computing entity 102 can also include volatile memory 322 and/or non-volatile memory 324, which can be embedded and/or can be removable. For example, the non-volatile memory can be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory can be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile memory 322 and/or the non-volatile memory 324 can store databases, database instances, database management systems, data, applications, programs, program modules, scripts, source code, object code, byte code, compiled code, interpreted code, machine code, executable instructions, and/or the like to implement the functions of the external computing entity 102. As indicated, this can include a user application that is resident on the entity or accessible through a browser or other user interface for communicating with the artificial intelligence computing entity 106 and/or various other computing entities.

In another embodiment, the external computing entity 102 can include one or more components or functionality that are the same or similar to those of the artificial intelligence computing entity 106, as described in greater detail above. As will be recognized, these architectures and descriptions are provided for exemplary purposes only and are not limiting to the various embodiments.

In various embodiments, the external computing entity 102 can be embodied as an artificial intelligence (AI) computing entity, such as a virtual assistant AI device, and/or the like. Accordingly, the external computing entity 102 can be configured to provide and/or receive information/data from a user via an input/output mechanism, such as a display, a camera, a speaker, a voice-activated input, and/or the like. In certain embodiments, an AI computing entity can comprise one or more predefined and executable program algorithms stored within an onboard memory storage module, and/or accessible over a network. In various embodiments, the AI computing entity can be configured to retrieve and/or execute one or more of the predefined program algorithms upon the occurrence of a predefined trigger event.

### IV. Exemplary System Operations

In general, embodiments of the present disclosure provide methods, apparatus, systems, computing devices, computing entities, and/or the like for providing event valuation forecasting using machine learning. Certain embodiments of the systems, methods, and computer program products that facilitate recommendation prediction and/or prediction-based actions employ one or more machine learning models and/or one or more machine learning techniques.

Various embodiments of the present disclosure address technical challenges related to accurately, efficiently and/or reliably performing predictive data analysis of data stored in disparate data sources. For example, in some embodiments, proposed solutions provide for utilization modeling using machine learning. In some embodiments, proposed solutions disclose event valuation modeling using machine learning. In some embodiments, one or more machine learning models to facilitate event valuation forecasting can be generated based at least in part on historical utilization data, historical valuation data, and/or historical event data. After the one or more machine learning models are generated, the one or more machine learning models can be utilized to perform accurate, efficient and reliable forecast event valuations.

Utilization Modeling using Machine Learning

FIG. 4 illustrates an example system 400 for utilization modeling using machine learning. In an embodiment, the system 400 can provide for forecasting utilization associated with a classification identifier using machine learning with respect to historical utilization data. In a non-limiting embodiment, the system 400 can provide for forecasting utilization associated with a medication using machine learning with respect to historical time-series data and/or other historical data associated with utilization of one or more medications. The system 400 includes a utilization model 402. In one or more embodiments, the modeling engine 110 can employ the utilization model 402 to forecast utilization associated with a classification identifier. In an embodiment, the classification identifier can be associated with a medication. In an embodiment, the classification identifier can be associated with a product (e.g., a healthcare product, a consumer product, a pharmaceutical product, etc.). In another embodiment, the classification identifier can be associated with an asset such as, for example, a device, a machine, equipment, or another type of asset. However, it is to be appreciated that the classification identifier can be associated with a different entity associated with a machine learning application. The utilization data 116 can be associated with one or more utilization features for the classification identifier. In one or more embodiments, the utilization model 402 can receive the utilization data 116 as input. The utilization data 116 can include, for example, one or more features employed by the utilization model 402 for utilization forecasting associated with the classification identifier. Input features for the utilization model 402 can include, for example, historic utilization for the classification identifier, one or more changes with respect to the classification identifier, one or more indicators for historical events associated with the classification identifier, and/or other utilization features associated with the classification identifier. In a non-limiting embodiment, input features for the utilization model 402 can include, for example, historic medication utilization for a medication, one or more changes in member enrollment with respect to the medication, one or more indicators for historical events associated with the medication (e.g., one or more indicators for previous medication launches, etc.), and/or other medication utilization features associated with the medication.

The utilization model 402 can be a regression machine learning model configured for utilization forecasting using the utilization data 116. For example, in various embodiments, the utilization model 402 is a trained machine learning model that is trained to provide utilization forecasting. In one or more embodiments, the utilization model 402 can be a linear regression model that employs one or more linear techniques for modeling relationships between respective portions of the utilization data 116. In an embodiment, the utilization model 402 can be an ordinary least squares (OLS) linear regression model that is configured to minimize an error margin (e.g., a sum of squared errors) between the one or more features of the utilization data 116 and one or more predicted future features related to utilization of the medication. Based on the modeling of the relationships between the respective portions of the utilization data 116, the utilization model 402 can generate forecasted utilization data 404. The forecasted utilization data 404 can include one or more utilization forecast features for the classification identifier associated with the utilization data 116. For example, the one or more utilization forecast features can represent a predicted future baseline utilization for the classification identifier associated with the utilization data 116. In a non-limiting embodiment, the one or more utilization forecast features can be one or more medication utilization forecast features for the medication. For instance, in certain embodiments, the utilization model 402 can be a medication utilization model that provides one or more medication utilization forecast features for the medication based on the utilization data 116. As such, in certain embodiments, the one or more utilization forecast features can represent a predicted future baseline utilization for a medication associated with the utilization data 116. In certain embodiments, the forecasted utilization data 404 can be formatted in a time series format. For instance, the one or more utilization forecast features can be indexed based on time to provide a time series representation of the one or more utilization forecast features. In certain embodiments, respective utilization forecast features can be associated with respective future timestamp values.

Event Valuation Modeling using Machine Learning

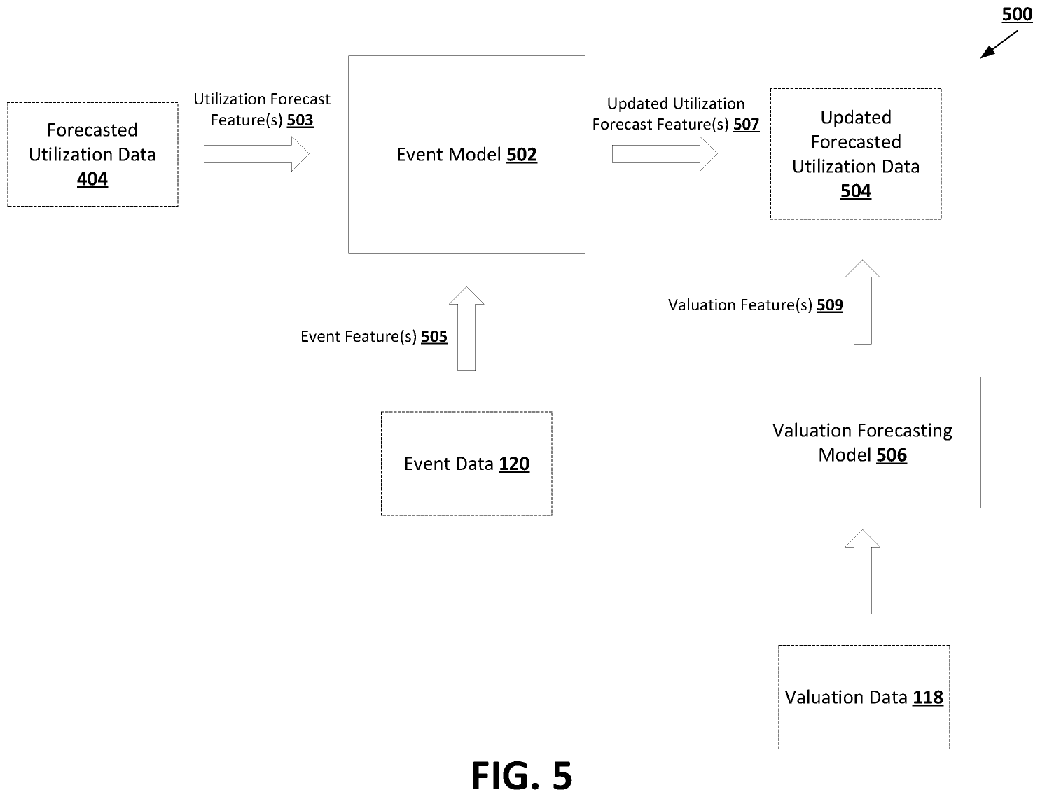

FIG. 5 illustrates an example system 500 for event valuation modeling using machine learning. In an embodiment, the system 500 can provide for updating a utilization forecast associated with a classification identifier using machine learning. In a non-limiting embodiment, the system 500 can provide for updating a utilization forecast associated with a medication using machine learning. The system 500 includes an event model 502. In one or more embodiments, the modeling engine 110 can employ the event model 502 to provide an updated utilization forecast associated with the classification identifier. In one or more embodiments, the event model 502 can receive the forecasted utilization data 404 and/or the event data 120 as input. The forecasted utilization data 404 can include the one or more utilization forecast features 503 associated with the classification identifier. The event data 120 can include one or more event features 505 for one or more events associated with the classification identifier. An event can correspond to a data entity that describes an event feature combination for the classification identifier. An example event may be an event feature combination for a medication launch (e.g., a drug launch). The one or more event features 505 may describe a medication launch type, a pharmacy type, a pharmacy name, a medication item, a medication formulation, a benefit design, and/or the like for the event.

The event model 502 can be a regression machine learning model configured for utilization forecasting using the utilization data 116. For example, in various embodiments, the event model 502 is a trained machine learning model that is trained to provide updated utilization forecasting. In various embodiments, the event model 502 can be configured as a first type of regression machine learning model that is different than the utilization model 402. For example, the utilization model 402 can be a first regression machine learning model and the event model 502 can be a second regression machine learning model that is configured differently than the first regression machine learning model.

In one or more embodiments, the event model 502 can be a linear regression model that employs one or more linear techniques associated with a regularization threshold value (e.g., a regularization center point) for modeling relationships between respective portions of the one or more utilization forecast features 503 and the one or more event features 505. In an embodiment, the event model 502 can be a Least Absolute Shrinkage and Selection Operator (LASSO) linear regression model that models relationships between the one or more utilization forecast features 503 and the one or more event features 505 based at least in part on the regularization threshold value. In certain embodiments, the one or more event features 505 can include one or more dynamic event features for a dynamic event associated with the classification identifier. For example, the one or more dynamic event features can be one or more medication launch features for a medication launch event associated with a market introduction of the medication. Additionally or alternatively, the one or more event features 505 can include one or more change event features for a change event associated with the classification identifier. For example, the one or more change event features can be one or more medication formulary change features for a medication formulary change event associated with the medication. As such, in certain embodiments, the event model 502 can be employed to update a medication utilization forecast due to formulary changes for the medication and/or generic launches for the medication. In various embodiments, input features for the event model 502 can include, for example, historic utilization associated with the classification identifier, predicted utilization associated with the classification identifier, tiered change identifiers associated with an event, utilization management status changes associated with an event, an average valuation associated with the classification identifier, a total number of classification identifiers within a class associated with the associated with the classification identifier, change authorizations associated with an event, and/or one or more other features associated with the classification identifier and/or an event. In a non-limiting embodiment, input features for the event model 502 can include, for example, historical utilization for a medication, predicted utilization for the medication, formulary tiering status changes with respect to the medication, utilization management status changes for the medication, average price of a medication, total number of medications in the therapeutic class for the medication, and/or continuation of therapy indicators for the medication.

Based on the modeling of the relationships between the respective portions of the one or more utilization forecast features 503 and the one or more event features 505, the event model 502 can generate one or more updated utilization forecast features 507 for the classification identifier associated with the utilization data 116. For example, the one or more updated utilization forecast features 507 can represent an updated predicted future utilization for the classification identifier associated with the utilization data 116. In certain embodiments, the one or more utilization forecast features 503 and the one or more event features 505 can be grouped based on respective time identifiers for the one or more utilization forecast features 503 and the one or more event features 505 to generate time-series groupings of attributes. The time-series groupings of attributes can also be provided as input to the event model 502 to facilitate generation of the one or more updated utilization forecast features 507. In a non-limiting embodiment, the one or more updated utilization forecast features 507 can be one or more updated medication utilization forecast features for the medication. For instance, in certain embodiments, the event model 502 can be a medication event model that provides one or more medication event features for the medication based on the utilization data 116. As such, in certain embodiments, the one or more updated utilization forecast features 507 can represent an updated predicted future utilization for a medication associated with the utilization data 116.

The system 500 also includes a valuation forecasting model 506. The valuation forecasting model 506 can provide one or more valuation features 509 for the classification identifier based on the valuation data 118. In various embodiments, the valuation forecasting model 506 can be a Weighted Compound Annual Growth Rate (CAGR) model configured to provide the or more valuation features 509 for the classification identifier based on the valuation data 118. For instance, the valuation forecasting model 506 can employ a weighted CAGR with respect to the valuation data 118 to provide the one or more valuation features 509. In various embodiments, the valuation data 118 can include one or more data entities that describe the valuation of the medication at respective times. An example valuation may be the price of a medication item associated with a medication launch and/or a pharmaceutical transaction. Input features for the valuation forecasting model 506 can include, for example, historic weighted growth rates for the medication and/or historic weighted medication valuations for the medication. In a non-limiting embodiment, the valuation forecasting model 506 employs weighted CAGR to predicts future prices for a medication. For example, a first year forecasted valuation for a medication can be based on an end of year valuation for the medication and an average weighted CAGR of three years (e.g., a 15% weight for a third year, a 35% weight for a second year, and a 50% weight for a first year). In another example, a second year forecasted valuation for the medication can be based on the first year forecasted valuation for the medication and an average weighted CAGR of three years (e.g., a 15% weight for a an average weighted CAGR of the three years, a 35% weight for the second year, and a 50% weight for the first year). In yet another example, a third year forecasted valuation for the medication can be based on the second year forecasted valuation for the medication and an average weighted CAGR of three years (e.g., a 15% weight for average weighted CAGR associated with the second year, a 35% weight for average weighted CAGR associated with the first year, and a 50% weight for the first year).

In one or more embodiments, the one or more updated utilization forecast features 507 and the one or more valuation features 509 can be combined to provide updated forecasted utilization data 504 associated with the classification identifier. The updated forecasted utilization data 504 can include updated utilization forecasts and/or updated valuation forecasts for the classification identifier associated with the utilization data 116. In certain embodiments, the one or more updated utilization forecast features 507 can be configured in an event driven format to facilitate combining the one or more updated utilization forecast features 507 and the one or more valuation features 509. For example, the one or more updated utilization forecast features 507 can be indexed based on respective event identifiers to provide an event representation of the one or more updated utilization forecast features 507. As such, in certain embodiments, respective updated utilization forecast features 507 can be associated with respective event identifiers. Furthermore, the one or more valuation features 509 can also be configured in the event driven format such that the one or more valuation features 509 are also indexed based on the respective event identifiers. In certain embodiments, the event model 502 can predict specific time intervals in the future by extrapolating linear lines between predicted time points to obtain predictions for intermediary intervals associated with the one or more updated utilization forecast features 507. For example, the event model 502 can be configured to predict utilization for certain future time intervals such as 6-month time intervals, 12-month time intervals, etc. In certain embodiments, predict utilization for certain future time interval can employ information (e.g., features) from one or more other predict future time intervals. For example, a 9-month prediction can be calculated from an extrapolated linear line between a 6-month time interval and a 12-month time interval.

Event Valuation Forecast Actions and/or Visualizations

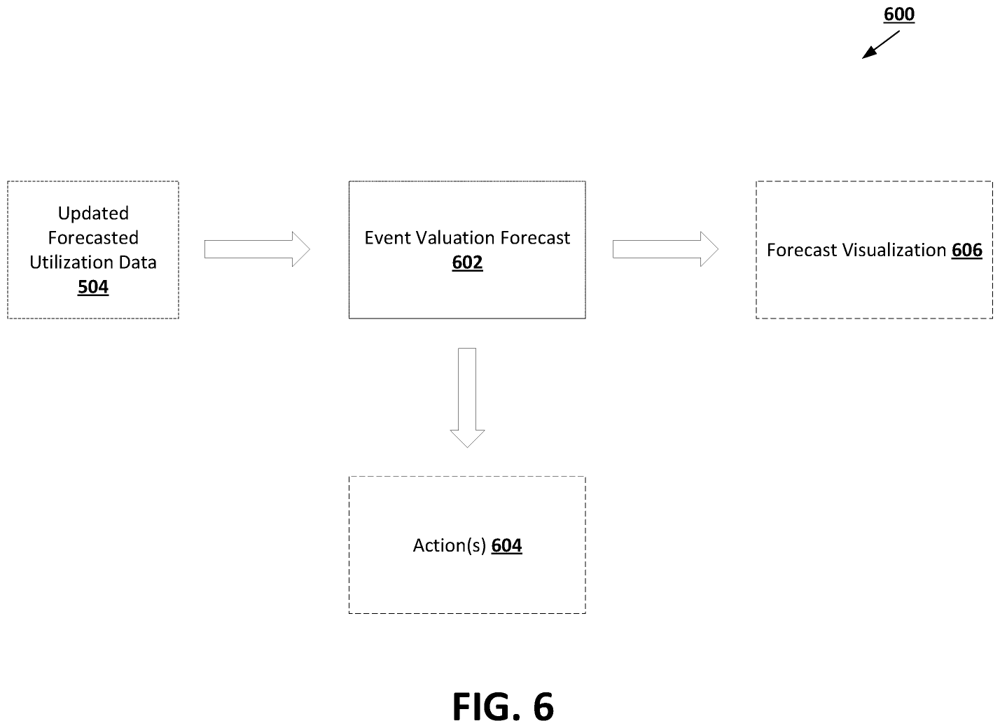

FIG. 6 illustrates an example system 600 for providing an event valuation forecast to facilitate one or more actions and/or one or more visualizations associated with the event valuation forecast. The system 600 includes an event valuation forecast 602. The event valuation forecast 602 can correspond to and/or can be determined based on the updated forecasted utilization data 504. For instance, the one or more updated utilization forecast features 507 can be combined with the one or more valuation features 509 to provide the updated forecasted utilization data 504 and/or the event valuation forecast 602. The event valuation forecast 602 can be a predicted valuation forecast for the classification identifier in response to the event associated with the event data 120. In certain embodiments, the event valuation forecast 602 can be a predicted wholesale acquisition cost for a medication associated with the classification identifier. In one or more embodiments, one or more actions 604 can be performed based at least in part on the event valuation forecast 602. For example, data associated with the event valuation forecast 602 can be stored in a storage system such as the storage subsystem 108 or another storage system associated with the artificial intelligence system 101. The data stored in the storage system can be employed for reporting, decision-making purposes, operations management, healthcare management, and/or other purposes. In certain embodiments, the data stored in the storage system can be employed to provide one or more insights to assist with healthcare decision making processes such as, for example, rebate optimization for a medication. Additionally or alternatively, the utilization model 402 and/or the event model 502 can be retrained based on one or more features associated with the event valuation forecast 602. For example, one or more relationships between features mapped in the utilization model 402 and/or the event model 502 can be adjusted (e.g., refitted) based on data associated with the event valuation forecast 602. In another example, cross-validation, hyperparameter optimization, and/or regularization associated with the utilization model 402 and/or the event model 502 can be adjusted based on one or more features associated with the event valuation forecast 602. Additionally or alternatively, a forecast visualization 606 can be generated based at least in part on the event valuation forecast 602. The forecast visualization 606 can include, for example, one or more graphical elements for an electronic interface (e.g., an electronic interface of a user device) based at least in part on the event valuation forecast 602.

### Regression Machine Learning Model Generation

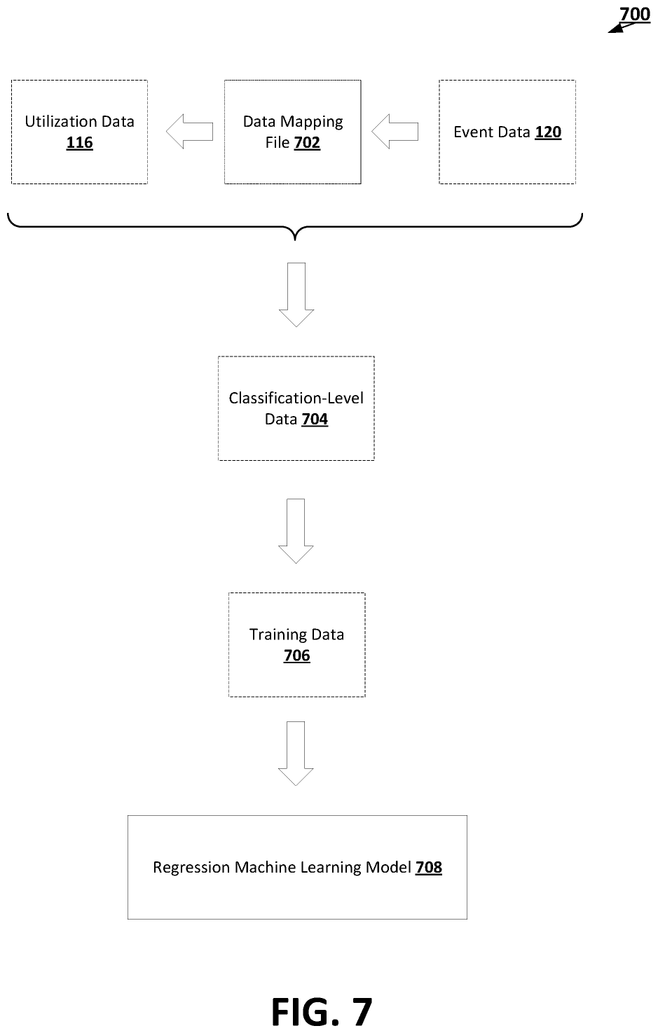

FIG. 7 illustrates an example system 700 for generating and/or training a regression machine learning model. In one or more embodiments, a data mapping file 702 is generated based on the event data 120. The data mapping file 702 can be a data structure configured to map data (e.g., features) based on respective event identifiers associated with the event data 120. In certain embodiments, one or more portions of the data mapping file 702 can be employed to generate one or more portions of the utilization data 116. The event data 120, the data mapping file 702, and/or the utilization data 116 can be employed to generate classification-level data 704. The classification-level data 704 can provide data related to a classification identifier. Training data 706 can also be generated based on the classification-level data 704. The training data 706 can be employed to generate a regression machine learning model 708. The regression machine learning model 708 can correspond to the utilization model 402 or the event model 502. In certain embodiments, the regression machine learning model 708 can be repeatedly trained based on the training data 708 until a quality criterion associated with a prediction for the regression machine learning model 708 is satisfied. For example, the regression machine learning model 708 can be repeatedly trained based on the training data 708 until relationships for utilization forecasting and/or event forecasting is appropriately tuned according to one or more tuning quality criteria.

Event Valuation Forecasting using Machine Learning

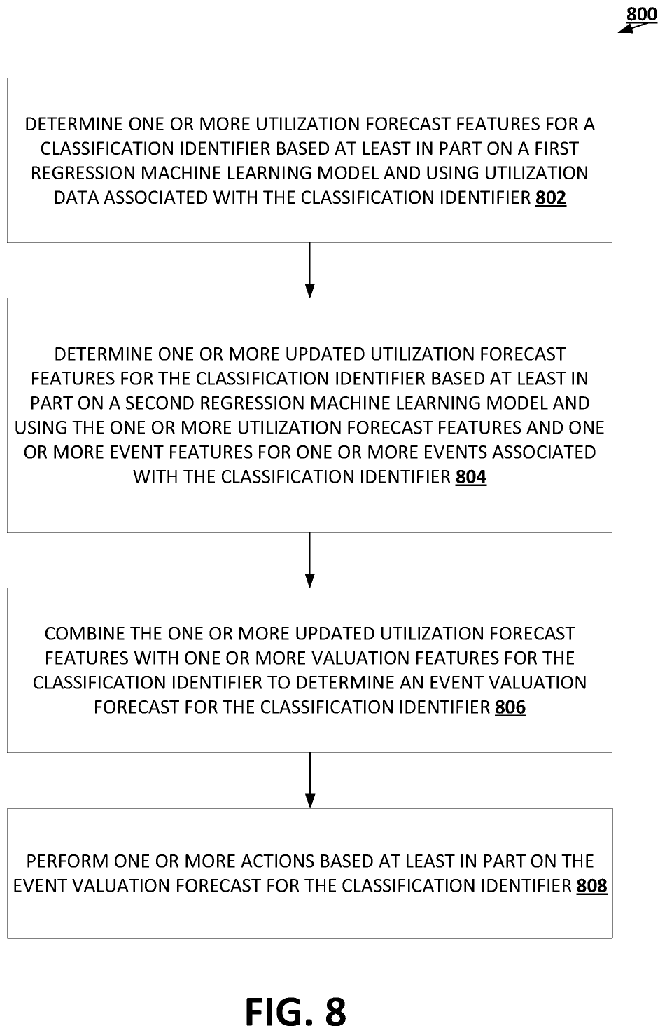

FIG. 8 is a flowchart diagram of an example process 800 for providing event valuation forecasting using machine learning. Via the various steps/operations of process 800, the artificial intelligence computing entity 106 can process the utilization data 116, the valuation data 118, and/or the event data 120 using one or more artificial intelligence techniques (e.g., one or more machine learning techniques) to provide improved event valuation forecasting. In doing so, the artificial intelligence computing entity 106 can utilize machine learning solutions to infer important predictive insights and/or inferences from the utilization data 116, the valuation data 118, and/or the event data 120.

The process 800 begins at step/operation 802 when the modeling engine 110 of the artificial intelligence computing entity 106 determines one or more utilization forecast features for a classification identifier based at least in part on a first regression machine learning model and using utilization data associated with the classification identifier. In certain embodiments, the modeling engine 110 of the artificial intelligence computing entity 106 determines the one or more utilization forecast features based at least in part on a time-series linear regression model that employs one or more linear techniques for modeling relationships between respective portions of the utilization data. In certain embodiments, the modeling engine 110 of the artificial intelligence computing entity 106 determines the one or more utilization forecast features based at least in part on an OLS linear regression model that is configured to minimize an error margin between one or more features of the utilization data and one or more predicted future features related to utilization of the classification identifier.

At step/operation 804, the modeling engine 110 of the artificial intelligence computing entity 106 determines one or more updated utilization forecast features for the classification identifier based at least in part on a second regression machine learning model and using the one or more utilization forecast features and one or more event features for one or more events associated with the classification identifier. In certain embodiments, the modeling engine 110 of the artificial intelligence computing entity 106 determines the one or more updated utilization forecast features based on a LASSO linear regression model that models relationships between the one or more utilization forecast features and the one or more event features based at least in part on a regularization threshold value. In certain embodiments, the modeling engine 110 of the artificial intelligence computing entity 106 determines one or more dynamic event features for a dynamic event associated with the classification identifier. Furthermore, in certain embodiments, the modeling engine 110 of the artificial intelligence computing entity 106 provides the one or more dynamic event features as input to the second regression machine learning model. In certain embodiments, the modeling engine 110 of the artificial intelligence computing entity 106 determines one or more change event features for a change event associated with the classification identifier. Furthermore, in certain embodiments, the modeling engine 110 of the artificial intelligence computing entity 106 provides the one or more change event features as input to the second regression machine learning model. In certain embodiments, the modeling engine 110 of the artificial intelligence computing entity 106 groups the one or more utilization forecast features and the one or more event features based on respective time identifiers to generate time-series groupings of attributes. Furthermore, in certain embodiments, the modeling engine 110 of the artificial intelligence computing entity 106 provides the time-series groupings of attributes as input to the second regression machine learning model.

At step/operation 806, the data forecasting engine 112 of the artificial intelligence computing entity 106 combines the one or more updated utilization forecast features with one or more valuation features for the classification identifier to determine an event valuation forecast for the classification identifier. In certain embodiments, the data forecasting engine 112 of the artificial intelligence computing entity 106 determines the one or more valuation features based on a weighted CAGR model configured to predict future valuations for the classification identifier.

At step/operation 808, the action engine 114 of the artificial intelligence computing entity 106 performs one or more actions based at least in part on the event valuation forecast for the classification identifier. In certain embodiments, the action engine 114 generates one or more graphical elements for an electronic interface based at least in part on the event valuation forecast for the classification identifier. In certain embodiments, the action engine 114 retrains the first regression machine learning model based at least in part on the event valuation forecast for the classification identifier. In certain embodiments, the action engine 114 retrains the second regression machine learning model based at least in part on the event valuation forecast for the classification identifier.

### V. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for event valuation forecasting, the computer-implemented method comprising:
determining one or more utilization forecast features for a classification identifier based at least in part on a first regression machine learning model and using utilization data associated with the classification identifier;
determining one or more updated utilization forecast features for the classification identifier based at least in part on a second regression machine learning model and using the one or more utilization forecast features and one or more event features for one or more events associated with the classification identifier;
combining the one or more updated utilization forecast features with one or more valuation features for the classification identifier to determine an event valuation forecast for the classification identifier; and
performing one or more actions based at least in part on the event valuation forecast for the classification identifier.

2. The computer-implemented method of claim 1, wherein the first regression machine learning model is a time-series linear regression model that employs one or more linear techniques for modeling relationships between respective portions of the utilization data, and wherein the determining the one or more utilization forecast features comprises determining the one or more utilization forecast features based at least in part on the time-series linear regression model.

3. The computer-implemented method of claim 1, wherein the first regression machine learning model is an Ordinary Linear Squares (OLS) linear regression model that is configured to minimize an error margin between one or more features of the utilization data and one or more predicted future features related to utilization of the classification identifier, and wherein the determining the one or more utilization forecast features comprises determining the one or more utilization forecast features based at least in part on the OLS linear regression model.

4. The computer-implemented method of claim 1, wherein the second regression machine learning model is a Least Absolute Shrinkage and Selection Operator (LASSO) linear regression model that models relationships between the one or more utilization forecast features and the one or more event features based at least in part on a regularization threshold value, and wherein the determining the one or more updated utilization forecast features comprises determining the one or more updated utilization forecast features based on the LASSO linear regression model.

5. The computer-implemented method of claim 1, further comprising:
determining one or more dynamic event features for a dynamic event associated with the classification identifier; and
providing the one or more dynamic event features as input to the second regression machine learning model.

6. The computer-implemented method of claim 1, further comprising:
determining one or more change event features for a change event associated with the classification identifier; and
providing the one or more change event features as input to the second regression machine learning model.

7. The computer-implemented method of claim 1, further comprising:
grouping the one or more utilization forecast features and the one or more event features based on respective time identifiers to generate time-series groupings of attributes; and
providing the time-series groupings of attributes as input to the second regression machine learning model.

8. The computer-implemented method of claim 1, further comprising:
determining the one or more valuation features based on a Weighted Compound Annual Growth Rate (CAGR) model configured to predict future valuations for the classification identifier.

9. The computer-implemented method of claim 1, wherein the performing the one or more actions comprises generating one or more graphical elements for an electronic interface based at least in part on the event valuation forecast for the classification identifier.

10. The computer-implemented method of claim 1, wherein the performing the one or more actions comprises retraining the first regression machine learning model based at least in part on the event valuation forecast for the classification identifier.

11. The computer-implemented method of claim 1, wherein the performing the one or more actions comprises retraining the second regression machine learning model based at least in part on the event valuation forecast for the classification identifier.

12. An apparatus for event valuation forecasting, the apparatus comprising at least one processor and at least one memory including a computer program code, the at least one memory and the computer program code configured to, with the at least one processor, cause the apparatus to:
determine one or more utilization forecast features for a classification identifier based at least in part on a first regression machine learning model and using utilization data associated with the classification identifier;
determine one or more updated utilization forecast features for the classification identifier based at least in part on a second regression machine learning model and using the one or more utilization forecast features and one or more event features for one or more events associated with the classification identifier;
combine the one or more updated utilization forecast features with one or more valuation features for the classification identifier to determine an event valuation forecast for the classification identifier; and
perform one or more actions based at least in part on the event valuation forecast for the classification identifier.

13. The apparatus of claim 12, wherein the first regression machine learning model is a time-series linear regression model that employs one or more linear techniques for modeling relationships between respective portions of the utilization data, and wherein the at least one memory and the computer program code are configured to, with the at least one processor, cause the apparatus to:
determine the one or more utilization forecast features based at least in part on the time-series linear regression model.

14. The apparatus of claim 12, wherein the first regression machine learning model is an Ordinary Linear Squares (OLS) linear regression model that is configured to minimize an error margin between one or more features of the utilization data and one or more predicted future features related to utilization of the classification identifier, and wherein the at least one memory and the computer program code are configured to, with the at least one processor, cause the apparatus to:
determine the one or more utilization forecast features based at least in part on the OLS linear regression model.

15. The apparatus of claim 12, wherein the second regression machine learning model is a Least Absolute Shrinkage and Selection Operator (LASSO) linear regression model that models relationships between the one or more utilization forecast features and the one or more event features based at least in part on a regularization threshold value, and wherein the at least one memory and the computer program code are configured to, with the at least one processor, cause the apparatus to:
determine the one or more updated utilization forecast features based on the LASSO linear regression model.

16. The apparatus of claim 12, wherein the at least one memory and the computer program code are configured to, with the at least one processor, cause the apparatus to:
determine one or more dynamic event features for a dynamic event associated with the classification identifier; and
provide the one or more dynamic event features as input to the second regression machine learning model.

17. The apparatus of claim 12, wherein the at least one memory and the computer program code are configured to, with the at least one processor, cause the apparatus to:
determine one or more change event features for a change event associated with the classification identifier; and
provide the one or more change event features as input to the second regression machine learning model.

18. The apparatus of claim 12, wherein the at least one memory and the computer program code are configured to, with the at least one processor, cause the apparatus to:
group the one or more utilization forecast features and the one or more event features based on respective time identifiers to generate time-series groupings of attributes; and
provide the time-series groupings of attributes as input to the second regression machine learning model.

19. The apparatus of claim 12, wherein the at least one memory and the computer program code are configured to, with the at least one processor, cause the apparatus to:
determine the one or more valuation features based on a Weighted Compound Annual Growth Rate (CAGR) model configured to predict future valuations for the classification identifier.

20. A non-transitory computer storage medium comprising instructions for event valuation forecasting, the instructions being configured to cause one or more processors to at least perform operations configured to:
determine one or more utilization forecast features for a classification identifier based at least in part on a first regression machine learning model and using utilization data associated with the classification identifier;
determine one or more updated utilization forecast features for the classification identifier based at least in part on a second regression machine learning model and using the one or more utilization forecast features and one or more event features for one or more events associated with the classification identifier;
combine the one or more updated utilization forecast features with one or more valuation features for the classification identifier to determine an event valuation forecast for the classification identifier; and
perform one or more actions based at least in part on the event valuation forecast for the classification identifier.
